(19) United States
(12) Patent Application Publication
(10) Pub. No.: US 2006/0016973 A1
(43) Pub. Date: Jan. 26, 2006

(54) Multi-chip image sensor package module

(75) Inventors: Jun-Young Yang, Kaohsiung (TW); Jong-Ho Han, Kaohsiung (TW); Jun-Hong Lee, Kaohsiung (TW)

Correspondence Address: TROXELL LAW OFFICE PLLC, SUITE 1404, 5205 LEESBURG PIKE, FALLS CHURCH, VA, 22041, US

(73) Assignee: Advanced Semiconductor Engineering, Inc.

(21) Appl. No.: 10/895,037

(22) Filed: Jul. 21, 2004

(51) Int. Cl. H01J 40/14

(52) U.S. Cl. 250/239

(57) ABSTRACT

A multi-chip image sensor package module includes a substrate having an opening, an IC chip, an image sensor chip and a glass cover. The IC chip includes a plurality of bumps on its mounting surface to mount on the lower surface of the substrate. The glass cover is disposed above the upper surface of the substrate. The image sensor chip is disposed between the mounting surface of the IC chip and the upper surface of the substrate by chip-to-chip attachment or flip-chip connection in a manner that the sensing region of the image sensor chip is aligned with the glass cover or a lens through the opening. Thus the multi-chip image sensor package module can have a thinner profile with lower assemble cost.

### FIELD OF THE INVENTION

The present invention relates to an image sensor package module, and more particularly to a multi-chip image sensor package module for accommodating an image sensor chip at low cost.

### BACKGROUND OF THE INVENTION

Conventionally, an image sensor chip is integrated in a package module with other IC chips such as digital signal processor, IC, for electrical integrity. However, the dimension and thickness of the package module will increase. As disclosed in U.S. Pat. No. 6,686,588, a conventional image sensor package module includes an image sensor chip and electronic components connected to a substrate. The image sensor chip is attached to the upper surface of the substrate by adhesive. A sidewall with locking features is mounted on the upper surface to form a chip cavity for accommodating the image sensor chip and to assemble with a lens housing. The electronic components and solder balls are disposed on the lower surface of the substrate to form a package module. The package module is thicker and has a higher packaging cost.

### SUMMARY OF THE INVENTION

A main purpose of the present invention is to provide a multi-chip image sensor package module comprising a substrate having an opening, an IC chip, an image sensor chip and a glass cover/lens. The IC chip including bumps is flip-chip mounted on the lower surface of the substrate. A chip cavity consists of the IC chip, the bumps and the opening of the substrate. The image sensor chip is disposed between the substrate and the IC chip so that the sensing region of the image sensor chip is aligned with the glass cover/lens via the opening. The package thickness of the multi-chip image sensor package module and the assemble cost can be reduced.

According to the present invention, a multi-chip image sensor package module comprises a substrate having an opening, an IC chip, an image sensor chip and a glass cover/lens. The opening is formed through the upper and lower surfaces of the substrate. The IC chip has a mounting surface and includes a plurality of bumps on the mounting surface. The IC chip is mounted on the lower surface of the substrate via the bumps. The bumps is formed at the peripheral region of the mounting surface without blocking the central region of the mounting surface, so that a chip cavity consists of the central region of the IC chip, the bumps and the opening of the substrate. The image sensor chip has an active surface and a backside surface. The active surface includes a sensing region smaller than the opening of the substrate. Moreover, the image sensor chip is disposed between the substrate and the IC chip inside the chip cavity in a manner that the sensing region is aligned with the glass cover/lens through the opening. Preferably, the central region of the mounting surface of the IC chip is no any bumps formed and is larger than the backside surface of the image sensor chip. The backside surface of the image sensor chip can be closer to the central region of the IC chip by chip-to-chip attachment on the central region or flip-chip mounting on the substrate. The glass cover/lens is disposed above the upper surface of the substrate to assemble a thin module.

### DESCRIPTION OF THE DRAWINGS

FIG. 1 is the cross-sectional view of the multi-chip image sensor package module according to the first embodiment of the present invention.

FIG. 2 is the cross-sectional view of the multi-chip image sensor package module according to the second embodiment of the present invention.

FIG. 3 is the cross-sectional view of the multi-chip image sensor package module according to the third embodiment of the present invention.

### DETAIL DESCRIPTION OF THE INVENTION

Please refer to the drawings attached, the present invention will be described by means of embodiments below.

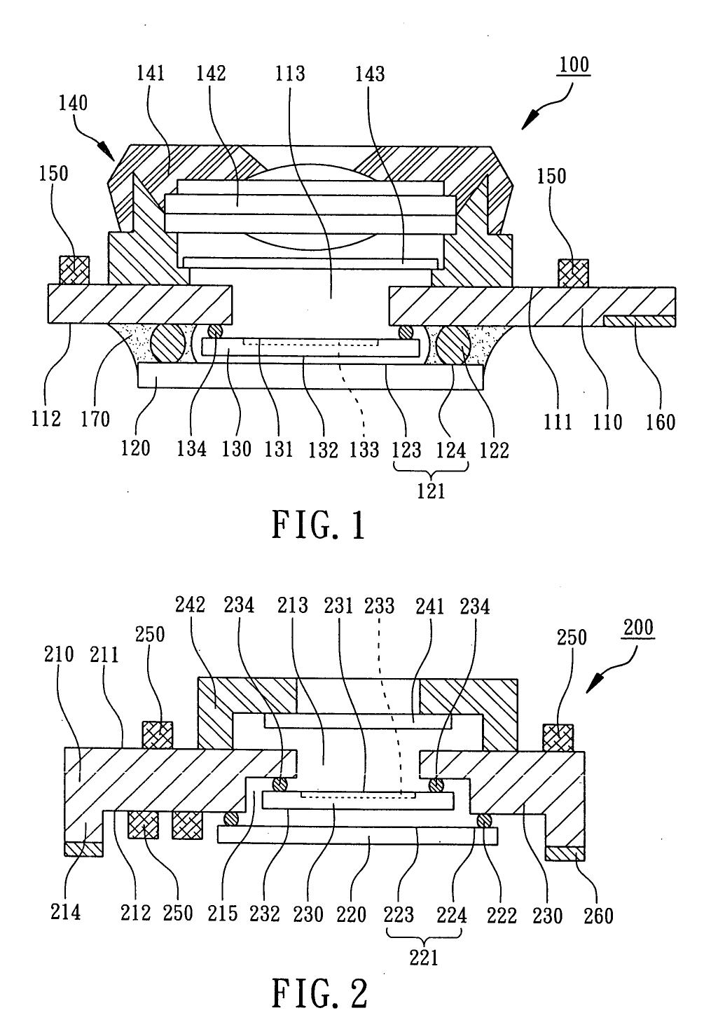

According to the first embodiment of the present invention, a multi-chip image sensor package module 100 is illuminated as shown in FIG. 1, which mainly includes a substrate 110, an IC chip 120 and an image sensor chip 130 and a lens 142. The substrate 110 may have a multi-layer circuits structure, such as a multi-layer co-fired ceramic, a MLCC, a printed circuited board (PCB), or a leadframe-based circuit board, for electrical connection of the IC chip 120 and the image sensor chip 130. The substrate 110 has an upper surface 111, a lower surface 112, and an opening 113 through the upper surface 111 and the lower surface 112.

According to the present embodiment, the IC chip 120 may be a flip chip or a chip scale package (CSP). The IC chip 120 has a mounting surface 121 and includes a plurality of bumps 122 formed on the mounting surface 121 of the IC chip 120. In this embodiment, the IC chip 120 is a DSP (Digital Signal Processor). The IC chip 120 is flip-chip mounted on the lower surface 112 of the substrate 110 via the bumps 122. The mounting surface 121 includes a central region 123 corresponding the backside surface 132 of the image sensor chip 130 and a peripheral region 124 around the central region 123. Bumps 122 are formed at the peripheral region 124 of the mounting surface 121 without blocking the central region 123. Therefore a chip cavity is formed which consists of the central region 123 of the IC chip 120, the bumps 122 and the opening 113 of the substrate 110. The image sensor chip 130 is disposed between the IC chip 120 and the substrate 110 inside the chip cavity, and can be even closer to the central region 123 of the IC chip 120. Furthermore, the dimension of the IC chip 120 should be larger than the image sensor chip 130.

The image sensor chip 130 has an active surface 131 and a backside surface 132. The active surface 131 includes a sensing region 133 for sensing images. The sensing region 133 is smaller than the opening 113 of the substrate 110. According to the embodiment, the opening 113 of the substrate 110 is smaller than the active surface 131 of the image sensor chip 130. The image sensor chip 130 is electrically connected to the substrate 110 by flip-chip mounting. The image sensor chip 130 includes a plurality of flip-chip bumps 134 to mount on the lower surface 112 of the substrate 110, wherein the sensing region 133 is aligned with the opening 113 of the substrate 110. Moreover, the area of the central region 123 of the IC chip 120 is almost equal to the area of the backside surface 132 of the image sensor chip 130. The bumps 122 connecting the lower surface 112 of the substrate 110 have a height larger than the thickness of the image sensor chip 130, so that the image sensor chip 130 can be disposed between the IC chip 120 and the substrate 110, and the active surface 131 and the backside surface 132 of the image sensor chip 130 are formed between the mounting surface 121 of the IC chip 120 the lower surface 112 of the substrate 110. The thickness of the multi-chip image sensor package module 100 can be reduced.

According to this embodiment, a lens module 140 is mounted on the upper surface 111 of the substrate 110. The lens module 140 includes a lens housing 141 to connect the lens 142. The lens housing 141 is airtightly connected to the substrate 110. Moreover, the lens 142 is aligned with the sensing region 133 of the image sensor chip 130 through the opening 113. Furthermore, a glass cover 143 is disposed above the upper surface 111 of the substrate 110 and is also aligned with the sensing region 133 of the image sensor chip 130 through the opening 113. According to this embodiment, the glass cover 143 is an IR-cut filter and is supported by the lens housing 141. Preferably, at least one passive component 150 is connected to the upper surface 111 or the lower surface 112. Moreover, an outer electrical connector 160, such as a flexible connector, can be connected to the lower surface 112 of the substrate 110 for outer connection.

In the multi-chip image sensor package module 100 mentioned above, the image sensor chip 130 is located between the substrate 110 and the IC chip 120 inside a composite chip cavity to achieve a thin module. Preferably, the package module 100 includes a filling material 170, such as a non-flow underfilling material, a non-conductive paste (NCP), or an anisotropic conductive paste (ACP). The filling material 170 is formed between the mounting surface 121 of the IC chip 120 and the lower surface 112 of the substrate 110 without contaminating the sensing region 133 of the image sensor chip 130 to encapsulate the bumps 122 and seal the image sensor chip 130. Therefore, the image sensor chip 130 is surrounded by an airtight space formed by the IC chip 120, the filling material 170, the opening 113 of the substrate 110 and the lens module 140 so that a thinner package module with lower package cost and excellent yield can be achieved.

According to the second embodiment of the present invention, as shown in FIG. 2. A multi-chip image sensor package module 200 mainly includes a substrate 210 having a opening 213, an IC chip 220, an image sensor chip 230 and a glass cover 241. The opening 213 passes through the upper surface 211 and the lower surface 212 of the substrate 210, and is larger than the image sensor chip 230 in size. A mounting base 242 connecting the glass cover 241 is mounted on the upper surface 211. The substrate 210 has a protruding layer 214 which is formed on periphery of the lower surface 212 for accommodating the IC chip 220. Moreover, the opening 213 of the substrate 210 has a stepping portion 215 toward the lower surface 212. The image sensor chip 230 is flip-chip mounted on the stepping portion 215 via a plurality of flip-chip bumps 234. The IC chip 220 is also mounted on the lower surface 212 inside the protruding layer 214. The IC chip 220 has a mounting surface 221 which includes a central region 223 and a peripheral region 224. A plurality of bumps 222 are formed at the peripheral region 224 of the mounting surface 221 without blocking the central region 223. The bumps 222 are connected on the lower surface 212 of the substrate 210. A chip cavity consists of the central region 223 of the IC chip 220, the bumps 222 and the opening 213 of the substrate 210 for accommodating the image sensor chip 230. The image sensor chip 230 has an active surface 231 and a backside surface 232. The active surface 231 includes a sensing region 233 smaller than the opening 213 of the substrate 210. The image sensor chip 230 includes a plurality of bumps 234, so that the image sensor chip 230 can be flip-chip mounted on the stepping portion 215 of the substrate 210. The image sensor chip 230 is disposed between the IC chip 220 and the substrate 210 in a manner that the sensing region 233 is aligned with the glass cover 241 through the opening 213 of the substrate 210. Moreover, the active surface 231 of the image sensor chip 230 is formed in the opening 213 between the upper surface 211 and the lower surface 212 of the substrate 210. Preferably, a plurality of passive components 250 are connected to the upper surface 211 and the lower surface 212 of the substrate 210. An outer electrical connector 260 is connected to the protruding portion 214 of the substrate 210 for outer electrical connection of the multi-chip image sensor package module 200. Therefore, the thickness of the multi-chip image sensor package module 200 can be thinner with lower assemble cost.

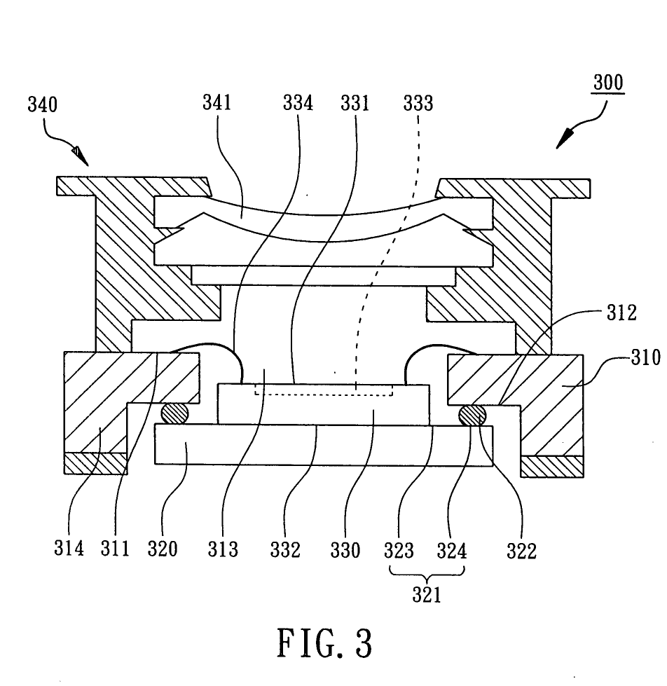

According to the third embodiment of the present invention, as shown in FIG. 3. A multi-chip image sensor package 300 mainly includes a substrate 310 having an opening 313, an IC chip 320, and an image sensor chip 330. The opening 313 of the substrate 310 passes through the upper surface 311 and the lower surface 312. The opening 313 is smaller than the sensing region 333 of the image sensor chip 330. In this embodiment, the opening 313 is larger than the active surface 331 of the image sensor chip 330. A lens module 340 having a lens 341 can be mounted on the upper surface 331 of the substrate 310. Preferably, the substrate 310 comprises a protruding layer 314 which is formed on the lower surface 312 for accommodating the IC chip 320. The IC chip 320 has a mounting surface 321 which includes a central region 323. A plurality of bumps 322 are formed at the peripheral region 324 of the mounting surface 321 without blocking the central region 323. The bumps 322 connect the lower surface 312 of the substrate 310. The image sensor chip 330 has an active surface 331 and a backside surface 332. The active surface 331 includes a sensing region 333 smaller than the opening 313. The backside surface 332 of the image sensor chip 330 can be attached to the central region 323 of the IC chip 320 by adhesive, the image sensor chip 330 is disposed between the substrate 310 and the IC chip 320 in a manner that the sensing region 333 is aligned with the lens 341 through the opening 313. The image sensor chip 330 is electrically connected to the substrate 310 via a plurality of bonding wires 334 so that the image sensor chip 330 can be stacked on the IC chip 320. The active surface 331 of the image sensor chip 330 is formed in the opening 313 between the upper surface 311 and the lower surface 312 of the substrate 310. Therefore, the thickness of the multi-chip image sensor package module 300 can be thinner with lower assemble cost.

The above description of embodiments of this invention is intended to be illustrative and not limiting. Other embodiments of this invention will be obvious to those skilled in the art in view of the above disclosure.

What is claimed is:

1. A multi-chip image sensor package module, comprising:
a substrate having an upper surface, a lower surface, and a opening through the upper surface and the lower surface;
an IC chip having a mounting surface and including a plurality of bumps formed on the mounting surface, the IC chip being mounted on the lower surface of the substrate via the bumps;
an image sensor chip having an active surface and a backside surface; wherein the active surface includes a sensing region smaller than the opening of the substrate; and
a lens module having a lens housing and a lens, wherein the lens housing is mounted on the upper surface of the substrate;
wherein the image sensor chip is disposed between the substrate and the IC chip in a manner that the sensing region is aligned with the lens through the opening.

2. The multi-chip image sensor package module of claim 1, wherein the mounting surface of the IC chip includes a central region corresponding to the backside surface of the image sensor chip and a peripheral region around the central region, the bumps are formed on the peripheral region without blocking the central region.

3. The multi-chip image sensor package module of claim 2, wherein the backside surface of the image sensor chip is attached to the central region of the IC chip.

4. The multi-chip image sensor package module of claim 3, further comprising a plurality of bonding wires connecting the image sensor chip and the substrate.

5. The multi-chip image sensor package module of claim 3, wherein the active surface of the image sensor chip is formed in the opening between the upper surface and the lower surface of the substrate.

6. The multi-chip image sensor package module of claim 1, wherein the image sensor chip is flip-chip mounted to the substrate.

7. The multi-chip image sensor package module of claim 6, wherein the backside surface of the image sensor chip is formed between the lower surface of the substrate and the mounting surface of the IC chip.

8. The multi-chip image sensor package module of claim 6, wherein the opening of the substrate has a stepping portion toward the lower surface for mounting the image sensor chip.

9. The multi-chip image sensor package module of claim 1, further comprising a filling material formed between the IC chip and the substrate to encapsulate the bumps.

10. The multi-chip image sensor package module of claim 1, wherein a glass cover is disposed above the upper surface of the substrate and is aligned with the opening.

11. The multi-chip image sensor package module of claim 10, wherein the glass cover is supported by the lens housing.

12. The multi-chip image sensor package module of claim 10, wherein the glass cover is an IR-cut filter.

13. The multi-chip image sensor package module of claim 1, wherein the substrate comprises a protruding layer formed on the lower surface for accommodating the IC chip.

14. The multi-chip image sensor package module of claim 1, further comprising a passive component connected to the substrate.

15. The multi-chip image sensor package module of claim 1, further comprising an electrical connector connected to the substrate.

16. The multi-chip image sensor package module of claim 1, wherein the IC chip is a chip scale package (CSP).

17. A multi-chip image sensor package module, comprising:
a substrate having an upper surface, a lower surface, and a opening through the upper surface and the lower surface;
an IC chip having a mounting surface and including a plurality of bumps formed on the mounting surface, the IC chip being mounted on the lower surface of the substrate via the bumps;
an image sensor chip having an active surface and a backside surface, wherein the active surface includes a sensing region smaller than the opening of the substrate; and
a glass cover disposed above the upper surface of the substrate;
wherein the image sensor chip is disposed between the substrate and the IC chip in a manner that the sensing region is aligned with the glass cover through the opening.

18. The multi-chip image sensor package module of claim 17, wherein the mounting surface of the IC chip includes a central region corresponding to the backside surface of the image sensor chip and a peripheral region around the central region;
the bumps are formed on the peripheral region without blocking the central region.

19. The multi-chip image sensor package module of claim 18, wherein the backside surface of the image sensor chip is attached to the central region, of the IC chip.

20. The multi-chip image sensor package module of claim 19, further comprising a plurality of bonding wires connecting the image sensor chip and the substrate.

21. The multi-chip image sensor package module of claim 19, wherein the active surface of the image sensor chip is formed in the opening between the upper surface and the lower surface of the substrate.

22. The multi-chip image sensor package module of claim 17, wherein the image sensor chip is flip-chip mounted to the substrate.

23. The multi-chip image sensor package module of claim 22, wherein the backside surface of the image sensor chip is formed between the lower surface of the substrate and the mounting surface of the IC chip.

24. The multi-chip image sensor package module of claim 22, wherein the opening of the substrate has a stepping portion toward the lower surface for mounting the image sensor chip.

25. The multi-chip image sensor package module of claim 17, further comprising a filling material formed between the IC chip and the substrate to encapsulate the bumps.

26. The multi-chip image sensor package module of claim 17, wherein the substrate comprises a protruding layer formed on the lower surface for accommodating the IC chip.

27. The multi-chip image sensor package module of claim 17, further comprising a passive component connected to the substrate.

28. The multi-chip image sensor package module of claim 17, further comprising an electrical connector connected to the substrate.

29. The multi-chip image sensor package module of claim 17, wherein the IC chip is a chip scale package (CSP).
